(19) United States
(12) Patent Application Publication
(10) Pub. No.: US 2019/0168245 A1
(43) Pub. Date: Jun. 6, 2019

(54) QUANTITATIVE PRESSING SPRAYER AND CONTAINER COMPRISING THE SAME

(71) Applicant: DERJIN (JIANGSU) PLASTIC PACKAGING CO. LTD, Jiangsu (CN)

(72) Inventor: Ya-Tsan WANG, Jiangsu (CN)

(73) Assignee: DERJIN (JIANGSU) PLASTIC PACKAGING CO. LTD, Jiangsu (CN)

(21) Appl. No.: 16/098,044

(22) PCT Filed: Apr. 18, 2017
(86) PCT No.: PCT/CN2017/080853

§ 371 Date: Oct. 31, 2018

(30) Foreign Application Priority Data
Jun. 2, 2016 (CN) 201610388799.5
Jun. 2, 2016 (CN) 201620533847.0

(51) Int. Cl. B05B 11/00

(52) U.S. Cl. CPC B05B 11/0005; B05B 11/0037

(57) ABSTRACT

A quantitative pressing sprayer includes a clamping plate, a pressing head, and a hand-held screw cap connected with a container. The pressing head penetrates through the hand-held screw cap. The clamping plate is pressed against and arranged on the pressing head. An end of the clamping plate is used as a fixed end that is connected with the hand-held screw cap. Another end of the clamping plate is used as a pressed end. The clamping plate drives the pressing head with the fixed end as a pivot of a lever. The pressed end and the fixed end form a first arm, the pressing head and the fixed end form a second arm, and the first arm is longer than the second arm.

### CROSS REFERENCE TO RELATED APPLICATIONS

The present application is a U.S. National Stage Entry of PCT/CN2017/080853, filed on Apr. 18, 2017, which claims foreign priority to CN 201610388799.05, filed on Jun. 2, 2016, and CN 20160533847.0, filed on Jun. 2, 2016.

### BACKGROUND OF THE INVENTION

### Field of the Invention

The present invention relates to a technical field for a sprayer, particularly to a quantitative pressing sprayer and a container comprising the same.

### Description of the Related Art

In daily life, many household supplies that people use are provided with pneumatic sprayers, which absorb liquid from a container through a tube according to the air pressure theory. For example, sprayers of containers accommodating bath liquid or hand washing liquid mostly use the tube to absorb the liquid. When in use, a pressing head on the tube is pressed down by one hand and a piston forced by the pressing head compresses the liquid in a cylinder. Simultaneously, the tube communicates with the cylinder and the bottom inlet of the cylinder is closed. The liquid in the cylinder is forced into the tube and sprayed out from the nozzle of the pressing head. When the pressing head is relaxed, the pressing head moves upward and returns its position under a force of a spring. At the same time, the tube separates from the cylinder and the bottom inlet of the cylinder is open. Thus, the inner pressure of the cylinder is smaller than that of the container. The liquid in the container is absorbed into the cylinder, such that the cylinder is filled with the liquid. The structure is conveniently used and effectively reduces the waste of the liquid. As a result, the structure is widely used. However, the structure has the following drawbacks.

First, the spring that supports the pressing head has a larger elastic force. A user requires more effort to press down the pressing down, especially for elders and children.

Second, when a great amount of liquid such as cloth washing liquid is used, the sprayer needs to be pressed several times due to the fact that the amount of the liquid sprayed by the sprayer is insufficient. Also, the measuring cup is used to precisely measure the amount of the liquid sprayed by the sprayer. That is, the sprayer needs to be pressed several times, which is inconvenient. If the liquid needs to be quantitatively sprayed, a sprayer with a great sprayed amount and a container and a cylinder corresponding to spray a great amount of liquid is required. However, the container becomes large and heavy. How to conveniently hold the container is a problem to be solved.

Third, in the conventional technology, the piston inclines in a horizontal direction when the pressing head is pressed down. Thus, the air tightness of the cylinder for the pressing head is reduced. Also, the pressing head is separated or broken when the container drops off from a height. Fourth, in the conventional technology, the straw of the sprayer cannot completely absorb liquid when the liquid in the container is too little. Fifth, the liquid in the container may be polluted by metal of the pressing head.

### SUMMARY OF THE INVENTION

To overcome the abovementioned problems, an objective of the present invention is to provide a quantitative pressing sprayer and a container comprising the same.

The quantitative pressing sprayer comprises a clamping plate, a pressing head, and a hand-held screw cap connected with a container. The pressing head penetrates through the hand-held screw cap. The clamping plate is pressed against and arranged on the pressing head. An end of the clamping plate is used as a fixed end that is connected with the hand-held screw cap. Another end of the clamping plate is used as a pressed end. The clamping plate drives the pressing head with the fixed end as a pivot of a lever. The pressed end and the fixed end form a first arm, the pressing head and the fixed end form a second arm, and the first arm is longer than the second arm.

In an embodiment of the present invention, the hand-held screw cap is provided with a long-tailed holding portion and an extending direction of the long-tailed holding portion is identical to an extending direction of the pressed end.

In an embodiment of the present invention, the hand-held screw cap is provided with a guiding groove, the pressing head is provided with a guiding protrusion corresponding to the guiding groove, and the pressing head uses the guiding protrusion to move back and forth along the guiding groove.

In an embodiment of the present invention, the hand-held screw cap is provided with a guiding rib, the pressing head is provided with a guiding groove corresponding to the guiding rib, and the pressing head uses the guiding groove to move back and forth along the guiding rib.

In an embodiment of the present invention, the quantitative pressing sprayer further comprises a pump and a straw. An end of the straw is connected with an inlet of a bottom of the pump. Another end of the straw far away from the pump is dipped into a liquid and provided with a curved portion, and the curved portion extends toward a direction that the pressing head sprays.

In an embodiment of the present invention, the quantitative pressing sprayer further comprises a non-return valve arranged at the inlet, and the non-return valve comprises plastic.

In an embodiment of the present invention, the non-return valve comprises an edge portion, an elastic portion, and a valve body. The edge portion is connected with the valve body. An upper end of the valve body is connected with the edge portion through the elastic portion. A lower end of the valve body corresponds to the inlet, the lower end of the valve body is attached to the inlet to separate the pump from a liquid in the container or the lower end of the valve body is separated from the inset to communicate the pump with the liquid in the container.

In an embodiment of the present invention, the quantitative pressing sprayer further comprises a fastener detachably connected between the pressed end of the clamping plate and the hand-held screw cap, thereby limiting displacement of the pressed end.

In an embodiment of the present invention, the quantitative pressing sprayer further comprises an elastic member and the pressing head further comprises a nozzle, a tube, and an annular groove. The tube and the nozzle form a liquid channel, the annular groove and the tube are coaxially arranged, the annular groove is arranged outside the tube, the elastic member sleeves an outer wall of the tube, an end of the elastic member is arranged in the annular groove, and another end of the elastic member is pressed against the hand-held screw cap.

In an embodiment of the present invention, the elastic member comprises a spring.

Based on the same concept, the present invention also provides a container comprising the quantitative pressing sprayer.

Compared with the conventional technology, the present invention has the following advantages.

The present invention uses a theory of levers. Due to the fact that torque and a reacting torque are equal, the applied force is smaller when an arm is longer. The present invention uses the fixed end of the clamping plate connected with the hand-held screw cap as a fulcrum, uses the clamping plate as a lever, and increases the distance between the pressed end and the fixed end to decrease the force for pressing the pressing head. The present invention is convenient and labor-saving.

The long-tailed holding portion of the present invention effectively overcomes a problem that a large container is held with one hand. Cooperating with the clamping plate, the long-tailed holding portion is easily controlled with one hand.

The present invention uses the guiding groove and the guiding rib or uses the guiding groove and the guiding protrusion to stably move the pressing head upward and downward along the hand-held screw cap, thereby overcoming the problem that the piston inclines in a horizontal direction during the conventional pressing head is pressed down, so as to reduce the air tightness of the cylinder for the pressing head.

The present invention installs a detachable fastener between the hand-held screw cap and the clamping plate to overcome a problem that the pressing head separates from the hand-held screw cap when the container drops off from a height and a problem with mis-pressing the clamping plate.

The present invention uses the curved portion of the straw to overcome a problem that the straw of the sprayer cannot fully absorb liquid when the conventional container accommodates too little liquid.

### BRIEF DESCRIPTION OF THE DRAWINGS

In order to more clearly illustrate the technical solutions of the embodiments of the present invention, the following drawings will be briefly described in the description of the embodiments. It is obvious that the drawings in the following description are only some embodiments of the present invention. Those skilled in the art can also obtain other drawings based on these drawings without paying any creative work. In the drawing:

FIG. 1 is a schematic diagram illustrating a process of pressing a quantitative pressing sprayer according to an embodiment of the present invention;

FIG. 2 is a structure schematic diagram illustrating a quantitative pressing sprayer according to an embodiment of the present invention;

FIG. 3 is a cross-sectional schematic diagram of a quantitative pressing sprayer according to an embodiment of the present invention;

FIG. 4 is an exploded view of a quantitative pressing sprayer according to an embodiment of the present invention;

FIG. 5 is a schematic diagram illustrating a container comprising a quantitative pressing sprayer held by one hand according to an embodiment of the present invention; and

FIG. 6 is a schematic diagram illustrating a container comprising a quantitative pressing sprayer held and pressed by one hand according to an embodiment of the present invention.

In the figures: 1—clamping plate, 2—pressing head, 3—spring, 4—tube, 5—hand-held screw cap, 6—piston, 7—cylinder, 8—packing sheet, 9—non-return valve, 10—straw, 11—container, 12—fastener, C—curved portion

### DETAILED DESCRIPTION OF THE INVENTION

The invention will now be described in detail by way of specific embodiments in conjunction with the accompanying drawings. The following examples are intended to further understand the invention, but are not intended to limit the invention in any way. It should be noted that other embodiments may be utilized, and structural and functional modifications may be made to the embodiments described herein without departing from the scope and spirit of the invention.

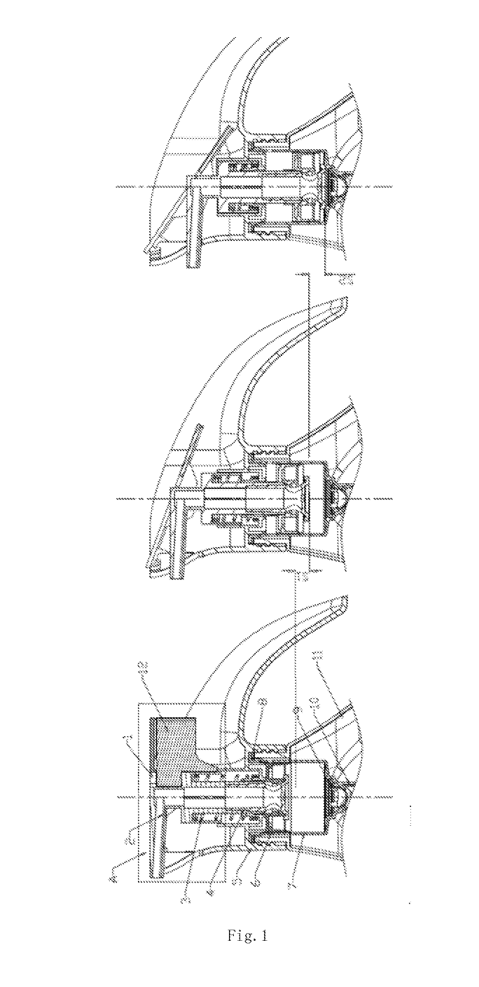

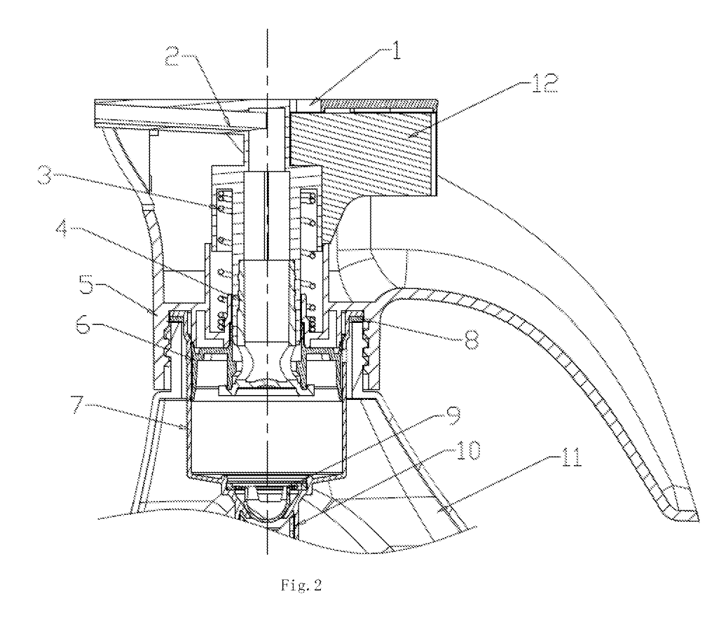

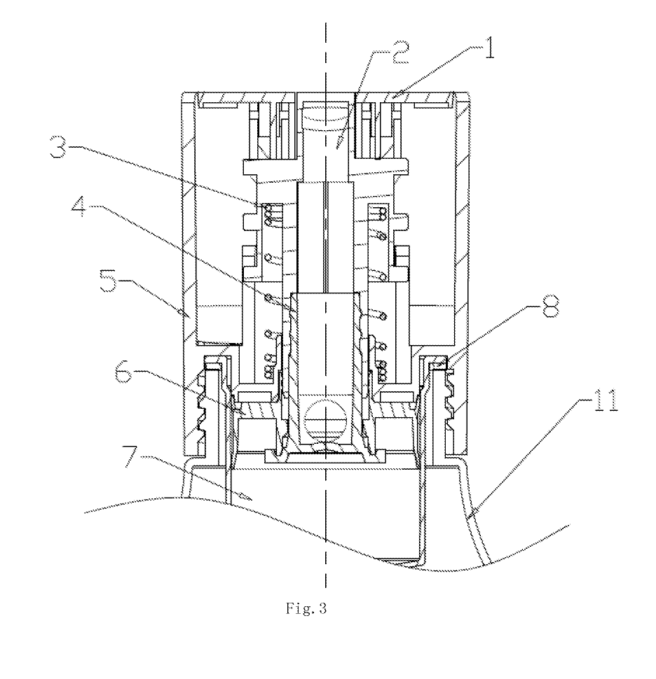

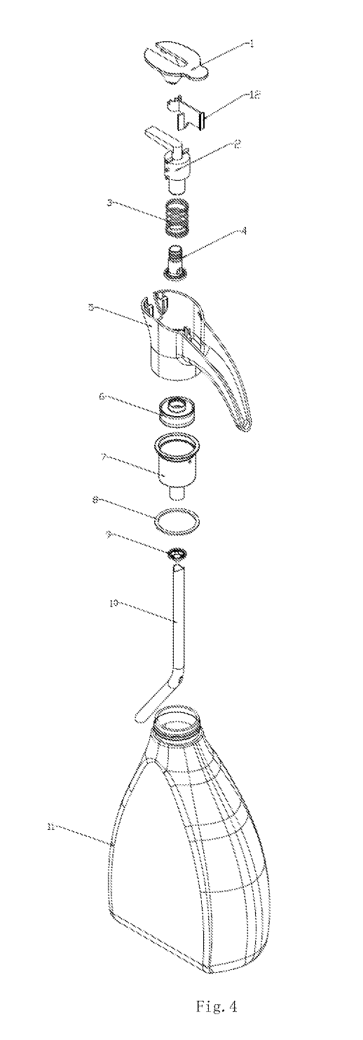

Referring to FIG. 1-FIG. 4, the present invention provides a quantitative pressing sprayer, which comprises a clamping plate 1, a pressing head 2, and a hand-held screw cap 5 connected with a container 11. The pressing head 2 penetrates through the hand-held screw cap 5, and the clamping plate 1 is pressed against and arranged on the pressing head 2.

An end of the clamping plate 1 is used as a fixed end that is connected with the hand-held screw cap 5, another end of the clamping plate 1 is used as a pressed end, the clamping plate 1 drives the pressing head 2 with the fixed end as the pivot of a lever, the pressed end and the fixed end form a first arm, the pressing head 2 and the fixed end form a second arm, and the first arm is longer than the second arm.

In an embodiment, the hand-held screw cap 5 is provided with a long-tailed holding portion and the extending direction of the long-tailed holding portion is identical to the extending direction of the pressed end.

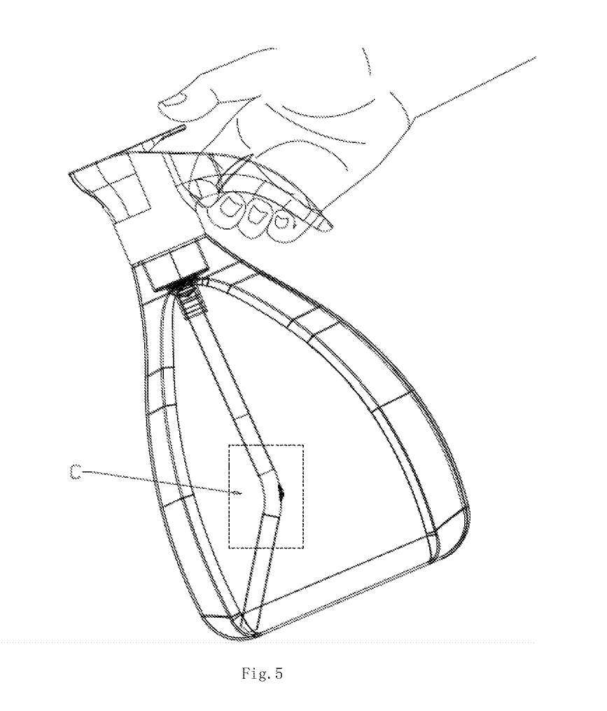

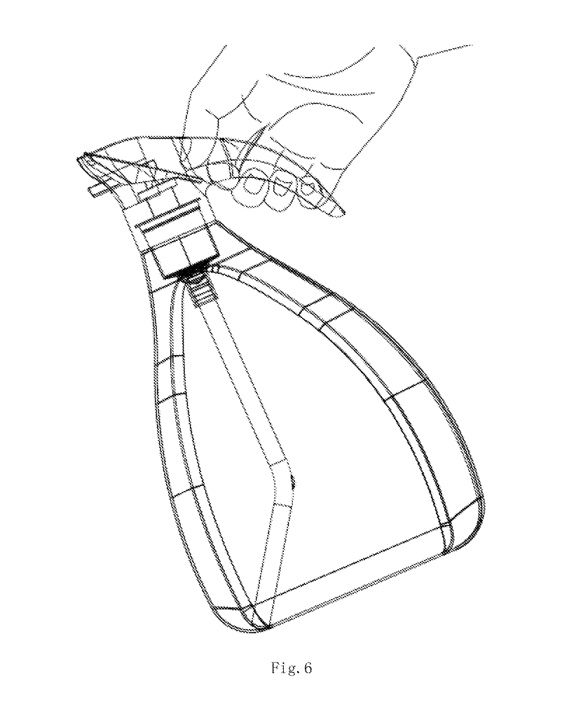

When a great amount of liquid is used, the sprayer needs to be pressed several times due to the fact that the amount of the liquid sprayed by the conventional sprayer is insufficient. In general, the liquid is poured into a measuring cup and used. However, the behavior cannot precisely measure the amount of liquid required and easily causes the additional waste of liquid. In order to spray a great amount of liquid, a container with large capacity is required. Thus, the container becomes large and heavy. The present invention changes the design of the long-tailed holding portion to improve the convenience of using the sprayer. As shown in FIGS. 1-4, the long-tailed holding portion is curved and extended toward the container 11. The side of the long-tailed holding portion that faces the hand-held screw cap 5 is provided with a convex and concave surface corresponding to fingers. The convex and concave surface may be provided with rubber to increase static friction with fingers. In the embodiment, the long-tailed holding portion has an ergonomic shape, such that the quantitative pressing sprayer is used for the heavier container 11. The long-tailed holding portion is conveniently held with one hand and the clamping plate 1 is pressed with one hand to comply with ergonomics and achieve the labor-saving purpose, as usage scenarios shown in FIG. 5 and FIG. 6.

In an embodiment, the hand-held screw cap 5 is provided with a guiding groove, the pressing head 2 is provided with a guiding protrusion corresponding to the guiding groove, and the pressing head 2 uses the guiding protrusion to move back and forth along the guiding groove. When the clamping plate 1 and the pressing head 2 are pressed down, the guiding groove and the guiding protrusion can prevent the pressing head 2 from being inclined to reveal the liquid and or connected unstably.

In an embodiment, the hand-held screw cap 5 is provided with a guiding rib, the pressing head 2 is provided with a guiding groove corresponding to the guiding rib, and the pressing head 2 uses the guiding groove to move back and forth along the guiding rib. The embodiment is a variation embodiment of the guiding groove and the guiding protrusion and has the same effect, but the present invention is not limited thereto.

In an embodiment, the quantitative pressing sprayer further comprises a pump and a straw 10. An end of the straw 10 is connected with the inlet of a bottom of the pump, another end of the straw 10 far away from the pump is dipped into a liquid and provided with a curved portion C, and the curved portion C extends toward a direction that the pressing head 2 sprays. When the liquid is too little, the container 11 comprising the quantitative pressing sprayer is held. The container 11 leans forward whereby the sprayer is close to the liquid. The liquid on the bottom of the container 11 flows to a position close to the sprayer and accumulates in the position. Since the curved direction of the curved portion C is the same to the direction that the liquid is sprayed, the tailed end of the curved portion C can coincides with the position where the remaining liquid accumulates, thereby completely absorbing the remaining liquid of the container 11, as shown in FIG. 5 and FIG. 6.

Since the straw 10 is made of plastic, the curved portion C is thermoplastically formed. When the straw 10 is curved, the back of the curved part has hard muscle strips, which prevent the straw 10 from rebounding. Thus, the curved angle is permanently fixed.

In an embodiment, the quantitative pressing sprayer further comprises a non-return valve 9 arranged at the inlet, and the non-return valve 9 comprises plastic. The non-return valve 9 does not belong to a type of a steel ball. The non-return valve 9 made of plastic prevents the liquid from touching metal and being polluted. Besides, the non-return valve 9 made of plastic, which has high elasticity, can better guarantee the air tightness. The angle of using the non-return valve 9 is not limited so to improve the convenience of using the sprayer.

In an embodiment, the non-return valve 9 comprises an edge portion, an elastic portion, and a valve body.

The edge portion is connected with the valve body, the upper end of the valve body is connected with the edge portion through the elastic portion, the lower end of the valve body corresponds to the inlet, the lower end of the valve body is attached to the inlet to separate the pump from the liquid in the container 11 or the lower end of the valve body is separated from the inset to communicate the pump with the liquid in the container 11.

In an embodiment, the quantitative pressing sprayer further comprises a fastener 12 detachably connected between the pressed end of the clamping plate 1 and the hand-held screw cap 5, thereby limiting the displacement of the pressed end.

In an embodiment, the quantitative pressing sprayer further comprises an elastic member and the pressing head 2 further comprises a nozzle, a tube 4, and an annular groove.

The tube 4 and the nozzle form a liquid channel, the annular groove and the tube 4 are coaxially arranged, the annular groove is arranged outside the tube 4, the elastic member sleeves the outer wall of the tube 4, an end of the elastic member is arranged in the annular groove, and another end of the elastic member is pressed against the hand-held screw cap 5. The elastic member externally arranged can overcome a problem that metal pollutes the liquid due to an elastic member internally arranged.

The elastic member comprises a spring, an elastic sheet, or elastic rubber, but the present invention is not limited thereto.

Based on the same concept, the present invention also provides a container 11 comprising the quantitative pressing sprayer, as shown in FIG. 5 and FIG. 6.

The present invention provides an embodiment described as follows.

The quantitative pressing sprayer comprises a clamping plate 1, a pressing head 2, a spring 3, a tube 4, a hand-held screw cap 5, a piston 6, a cylinder 7, a packing sheet 8, a non-return valve 9, and a straw 10. In the embodiment, the elastic member is the spring.

1. Step S1 (as shown in FIG. 1):

The clamping plate 1 is pressed down to compress the spring 3, such that the pressing head 2 moves the tube 4 downward. Simultaneously, the piston 6 receives the friction of the inner wall of the cylinder 7 and maintains to be static. The valve port of the tube 4 which is temporarily closed by the piston is gradually open. When the clamping plate 1, the pressing head 2, and the tube 4 move the displacement S1, the valve port is completely open.

### 2. Step S2 (as Shown in FIG. 1):

After Step S1, the clamping plate 2 is still pressed down to compress the spring 3. The tube 4 starts to move the piston 6 downward until Step S2 ends. During Step S2, the pressing head 2 uses the piston 6 to compress the internal space of the cylinder 7 through the tube 4. The bottom of the cylinder 7 is closed by the non-return valve. The liquid in the cylinder 7 enters into the tube 4 whereby the upper pressing head 2 sprays the liquid. Steps S1 and S2 in FIG. 1 are a continuous process in a practical operation.

### 3. Return Position (as Shown in FIG. 1):

When the clamping plate 1 is relaxed, the pressing head 2 is moved upward by the elastic force of the spring 3, and drives the tube 4 to move up together. In the beginning, the piston 6 receives the friction of the inner wall of the cylinder 7 and maintains to be static. Also, the valve port of the lower end of the tube 4 moves up to enter into the piston 6 and closes. After closing the valve port, the clamping plate 2, the tube 4, and the piston 6 continue moving upward under the elasticity of the spring 3, thereby making the internal space of the cylinder 7. At the same time, the non-return valve 9 is opened since the internal pressure of the cylinder 7 is smaller than that of the container. In addition, the bottom inlet of the cylinder 7 is synchronously turned on and the liquid in the container enters into the cylinder 7. Since the pressing head 2 returns to its original position, the liquid gradually fills the cylinder 7. The pressing head 2, the tube 4, and the piston 6 continue moving upward. When the pressing head presses against the clamping plate 1 to touch the top displacement-limited structure of the hand-held screw cap 5 or when the spring 3 recovers its original length, the pressing head 2 stops moving upward, the liquid fills the cylinder 7, and the non-return valve 9 is closed to complete the position-returning process.

The above are only the preferred embodiments of the present invention, and those skilled in the art can make various changes or equivalents to these features and embodiments without departing from the spirit and scope of the invention. In addition, these features and embodiments may be modified to adapt to the specific circumstances and materials without departing from the spirit and scope of the invention. Therefore, the present invention is not limited by the specific embodiments disclosed herein, and all the embodiments falling within the scope of the claims of the present invention fall within the scope of the invention.

1. A quantitative pressing sprayer comprising:
a hand-held screw cap connected with a container;
a pressing head penetrating through the hand-held screw cap; and
a clamping plate pressed against and arranged on the pressing head, the clamping plate comprising:
a fixed end connected with the hand-held screw cap; and
a pressed end,
wherein the clamping plate drives the pressing head with the fixed end as a pivot of a lever, and
wherein the pressed end and the fixed end form a first arm, the pressing head and the fixed end form a second arm, and the first arm is longer than the second arm.

2. The quantitative pressing sprayer of claim 1, wherein the hand-held screw cap is provided with a long-tailed holding portion and an extending direction of the long-tailed holding portion is identical to an extending direction of the pressed end.

3. The quantitative pressing sprayer of claim 1, wherein the hand-held screw cap is provided with a guiding groove, the pressing head is provided with a guiding protrusion corresponding to the guiding groove, and the pressing head uses the guiding protrusion to move back and forth along the guiding groove.

4. The quantitative pressing sprayer of claim 1, wherein the hand-held screw cap is provided with a guiding rib, the pressing head is provided with a guiding groove corresponding to the guiding rib, and the pressing head uses the guiding groove to move back and forth along the guiding rib.

5. The quantitative pressing sprayer of claim 1, further comprising:
a pump, the pump comprising a bottom having an inlet; and
a straw, the straw comprising:
a first end connected with the of the pump; and
a second end, disposed further from the pump than the first end, dipped into a liquid and provided with a curved, portion extending toward a direction that the pressing head sprays.

6. The quantitative pressing sprayer of claim 5, further comprising a plastic non-return valve arranged at the inlet.

7. The quantitative pressing sprayer of claim 6, wherein the non-return valve comprises:
an elastic portion;
a valve body having an upper end and a lower end, the lower end of the valve body corresponding to the inlet and being attached to the inlet to separate the pump from a liquid in the container or the lower end of the valve body is separated from the inset to communicate the pump with the liquid in the container; and
an edge portion connected with the valve body, the upper end of the valve body being connected with the edge portion through the elastic portion.

8. The quantitative pressing sprayer of claim 1, further comprising a fastener detachably connected between the pressed end of the clamping plate and the hand-held screw cap, thereby limiting displacement of the pressed end.

9. The quantitative pressing sprayer of claim 1, further comprising an elastic member,
wherein the pressing head further comprises:
a nozzle;
a tube; and
an annular groove,
wherein the tube and the nozzle form a liquid channel,
wherein the annular groove and the tube are coaxially arranged,
wherein the annular groove is arranged outside the tube,
wherein the elastic member sleeves an outer wall of the tube,
wherein an end of the elastic member is arranged in the annular groove, and
wherein another end of the elastic member is pressed against the hand-held screw cap.

10. The quantitative pressing sprayer of claim 9, wherein the elastic member comprises a spring.

11. A container comprising the quantitative pressing of claim 1.
